(19) United States
(12) Patent Application Publication
(10) Pub. No.: US 2025/0044440 A1
(43) Pub. Date: Feb. 6, 2025

(54) NEW RADIO (NR) ROUND TRIP TIME (RTT) USING CARRIER PHASE

(71) Applicant: QUALCOMM Incorporated, San Diego, CA (US)

(72) Inventors: Srinivas Yerramalli, San Diego, CA (US); Alexandros Manolakos, Athens (GR); Xiaoxia Zhang, San Diego, CA (US)

(21) Appl. No.: 18/717,363

(22) PCT Filed: Feb. 7, 2023
(86) PCT No.: PCT/US2023/062131

§ 371 Date: Jun. 6, 2024

(30) Foreign Application Priority Data
Mar. 4, 2022 (GR) 20220100203

(51) Int. Cl. G01S 13/76; H04W 64/00

(52) U.S. Cl. CPC G01S 13/765; H04W 64/00

(57) ABSTRACT

This disclosure provides systems, methods, and devices for wireless communication that support RTT for NR. In a first aspect, a method of wireless communication includes receiving, at a network entity, a multiple sets of round trip time (RTT) information associated with a user equipment (UE), each RTT information of the multiple sets of RTT information associated with a different network entity. The method also includes determining a position associated with the UE based on the multiple sets of RTT information.

### TECHNICAL FIELD

Aspects of the present disclosure relate generally to wireless communication systems, and more particularly, to round trip time (RTT) for new radio (NR). Some features may enable and provide improved communications, including improved positioning information using carrier phase.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

With the introduction of 5^{th} Generation (5G) or new radio (NR) networks (sometimes referred to as “5G NR” networks/systems/devices), UEs are able to have higher capability, higher data rate, higher bandwidth. Additionally, UEs are also able to operate in a variety of architectures that provide dual connectivity. As devices continue to improve and “do more”, networks and devices of the network may be unsynchronized which may make determining positioning information difficult.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes generating, by a UE, first downlink (DL) phase information based on a first round trip time (RTT) associated with a first network entity; generating, by the UE, second DL phase information based on a second RTT associated with a second network entity; and obtaining, by the UE, a position associated with the UE based on the first DL phase information and the second DL phase information.

In an additional aspect of the disclosure, an apparatus includes at least one processor and a memory coupled to the at least one processor. The at least one processor is configured to generate first downlink (DL) phase information based on a first round trip time (RTT) associated with a first network entity; generate second DL phase information based on a second RTT associated with a second network entity; and obtain a position associated with the UE based on the first DL phase information and the second DL phase information.

In an additional aspect of the disclosure, an apparatus includes means for generating first downlink (DL) phase information based on a first round trip time (RTT) associated with a first network entity. The apparatus further includes means for generating second DL phase information based on a second RTT associated with a second network entity. The apparatus also includes obtaining a position associated with the UE based on the first DL phase information and the second DL phase information.

In an additional aspect of the disclosure, a non-transitory computer-readable medium stores instructions that, when executed by a processor, cause the processor to perform operations. The operations include generating first downlink (DL) phase information based on a first round trip time (RTT) associated with a first network entity; generating second DL phase information based on a second RTT associated with a second network entity; and obtaining a position associated with the UE based on the first DL phase information and the second DL phase information.

In an additional aspect of the disclosure, an apparatus configured for wireless communication includes at least one processor or modem, and a memory coupled to the at least one processor. The at least one processor or modem is configured to generate first DL phase information based on a first RTT associated with a first network entity, generate second DL phase information based on a second RTT associated with a second network entity, and obtain a position associated with the UE based on the first DL phase information and the second DL phase information.

In an additional aspect of the disclosure, a method for wireless communication includes receiving, at a network entity, a multiple sets of round trip time (RTT) information associated with a user equipment (UE), each RTT information of the multiple sets of RTT information associated with a different network entity; and determining a position associated with the UE based on the multiple sets of RTT information.

In an additional aspect of the disclosure, an apparatus includes at least one processor and a memory coupled to the at least one processor. The at least one processor is configured to receive, at a network entity, a multiple sets of round trip time (RTT) information associated with a user equipment (UE), each RTT information of the multiple sets of RTT information associated with a different network entity; and determine a position associated with the UE based on the multiple sets of RTT information.

In an additional aspect of the disclosure, an apparatus includes means for receiving, at a network entity, a multiple sets of round trip time (RTT) information associated with a user equipment (UE). Each RTT information of the multiple sets of RTT information associated with a different network entity. The apparatus further includes means for determining a position associated with the UE based on the multiple sets of RTT information.

In an additional aspect of the disclosure, a non-transitory computer-readable medium stores instructions that, when executed by a processor, cause the processor to perform operations. The operations include receiving, at a network entity, a multiple sets of round trip time (RTT) information associated with a user equipment (UE), each RTT information of the multiple sets of RTT information associated with a different network entity; and determining a position associated with the UE based on the multiple sets of RTT information.

In an additional aspect of the disclosure, an apparatus configured for communication includes at least one processor or modem, and an interface coupled to the at least one processor or modem. The interface is configured to receive a multiple sets of RTT information associated with a UE. Each RTT information of the multiple sets of RTT information is associated with a different network entity. The at least one processor or modem is configured to determine a position associated with the UE based on the multiple sets of RTT information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station (BS) and a user equipment (UE) according to one or more aspects.

FIG. 3 is a block diagram illustrating an example wireless communication system that supports round trip time (RTT) for new radio (NR) according to one or more aspects.

FIG. 4 is a ladder diagram illustrating an example wireless communication system that supports RTT for NR according to one or more aspects.

FIG. 5 is a ladder diagram illustrating an example wireless communication system that supports RTT for NR according to one or more aspects.

FIG. 6 is a block diagram illustrating details of an example wireless communication system according to one or more aspects

FIG. 7 is a flow diagram illustrating an example process that supports RTT for NR according to one or more aspects.

FIG. 8 is a block diagram of an example UE that supports RTT for NR according to one or more aspects.

FIG. 9 is a flow diagram illustrating an example process that supports RTT for NR according to one or more aspects.

FIG. 10 is a block diagram of an example network entity that supports RTT for NR according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Carrier phase methods have originated in the Global Navigation Satellite System (GNSS) world to determine position. For example, carrier phase methods have been used in GNSS systems in which a reference receiver with a known location. Additionally, carrier phase methods typically include a double difference method using a reference receiver with known position to provide timing and phase correction measurements to a target UE and improve positioning accuracy. A primary assumption for carrier phase methods is that the network is synchronized. However, carrier phase methods have yet to be adapted to unsynchronized networks.

The present disclosure provides systems, apparatus, methods, and computer-readable media that support RTT for NR. For example, the RTT for NR utilizes carrier phase to determine a position of a target device, such as a user equipment (UE). To illustrate, a UE may perform RTT operations with multiple network entities of a network, such as an asynchronous network. Each RTT operation may be associated with corresponding RTT information, such as a downlink (DL) carrier frequency associated with the RTT operation, an uplink (UL) carrier frequency associated with the RTT operation, DL phase information associated with the RTT operation, UL phase information associated with the RTT operation, or a combination thereof. To illustrate, the UE and a network device may perform a first RTT operation using a first DL carrier frequency and a first UL carrier frequency. Based on the first RTT operation, the UE determines the DL phase information and the network entity determines the UL phase information. In some implementations, each of the UE and the network entity is configured to maintain a phase during a time division duplex (TDD) switch.

For each RTT operation, the corresponding RTT information is provided to a device, such as the UE or a core network (e.g., a location management function (LMF)) to determine a position of the UE. To determine the position, the device determines, for each RTT operation, a corresponding constraint based on the RTT information associated with the RTT operation. To illustrate, a first constraint associated with the first RTT operation may include a relationship between a first condition and a second condition. For example, the first condition may be a wavelength of the DL carrier frequency multiplied by a sum of a DL parameter and a first fractional wavelength value, where the first fractional wavelength value based on the DL phase information. The second condition may be based on a wavelength of the UL carrier frequency multiplied by a sum of an UL parameter and a second fractional wavelength value, the second fractional wavelength value based on the UL phase information. The DL parameter may include a DL cycle ambiguity and the UL parameter may include a UL cycle ambiguity. In some implementations, the DL parameter includes a first integer value that represents a first number of wavelengths associated with the DL carrier frequency, and the UL parameter includes a second integer value that represents a second number of wavelengths associated with the UL carrier frequency.

The device may determine, for the first constraint associated with the first RTT operation, a set of candidate values for the DL parameter and the UL parameter that satisfy the constraint determined for the RTT information. The set of candidate values may include one or more candidate pairs of DL and UL parameters that satisfy the first constraint. Each set of candidate values for the first constraint may be associated with a candidate distance between the UE and the first network entity corresponding to the first RTT operation. Additionally, the device may determine other sets of candidate values for other RTT operations performed with the UE and other network entities. Based on the sets of candidate values for multiple RTT operations, the device may determine a position associated with the UE.

Particular implementations of the subject matter described in this disclosure may be implemented to realize one or more of the following potential advantages or benefits. In some aspects, the present disclosure provides techniques for use of carrier phase in NR for multi-RTT to determine position information of a device included in a network, such as an asynchronous network. Additionally, the techniques may improve position accuracy, reduce overhead communication, and improve system efficiency.

Wireless devices may share access in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.99999% reliability), ultra-low latency (e.g., ˜1 millisecond (ms)), and users with wide ranges of mobility or lack thereof, and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

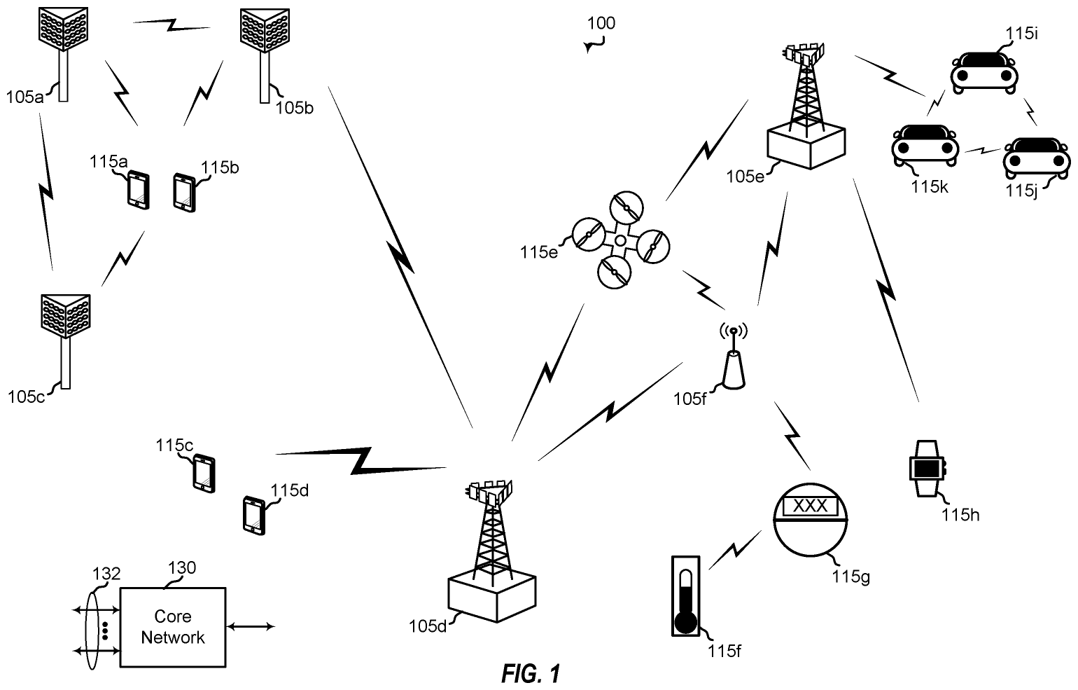

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports ultra-reliable and redundant links for devices, such UE 115e. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF), which is an entity in the 5G Core Network (5GC) supporting various functionality, such as managing support for different location services for one or more UEs. For example the LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via an Access and Mobility Management Function (AMF).

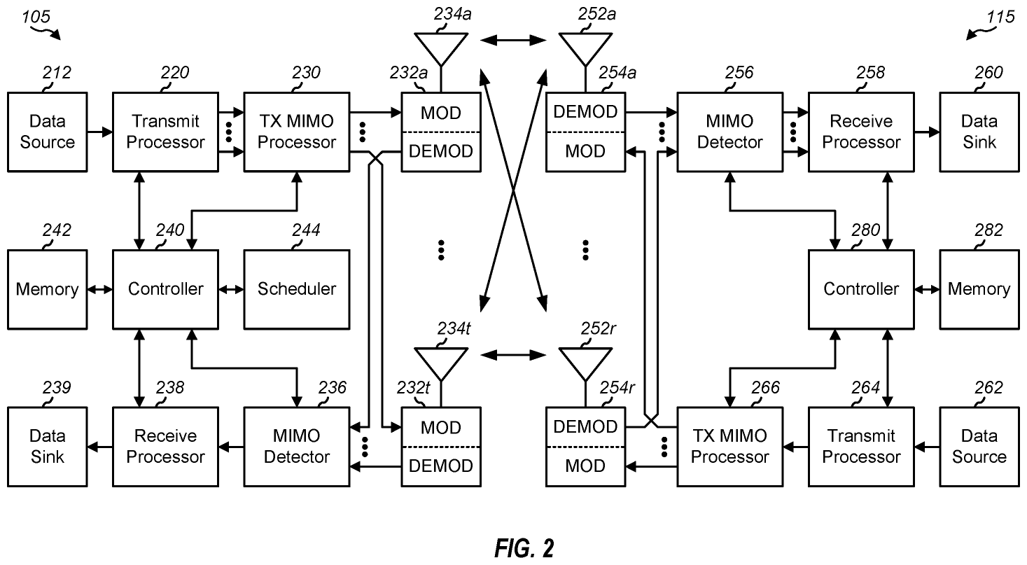

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. Additionally, or alternatively, base station 105 may include or correspond to another device, such as a network entity. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

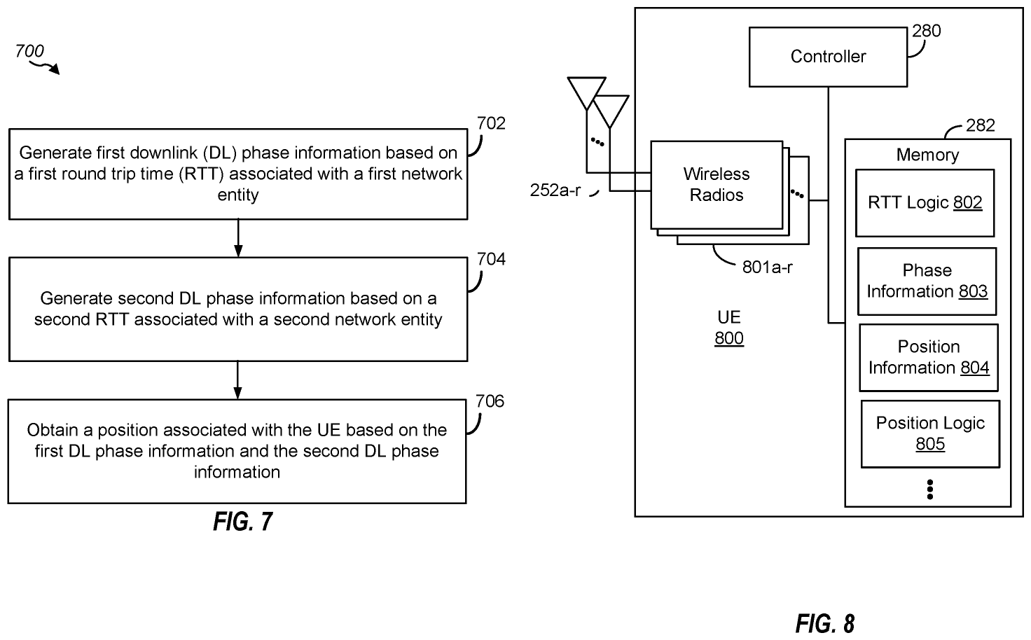

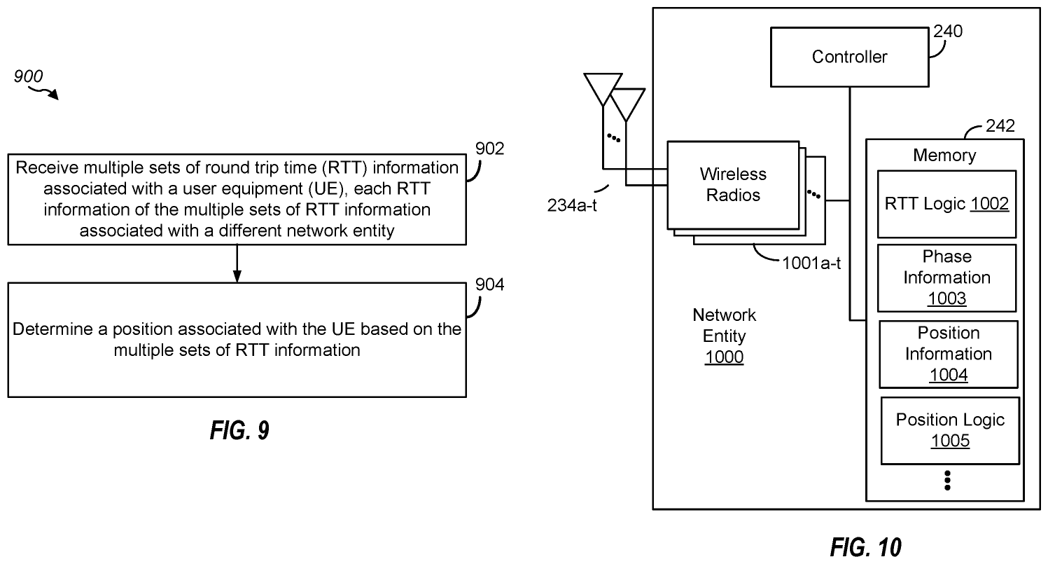

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 7 or 9, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

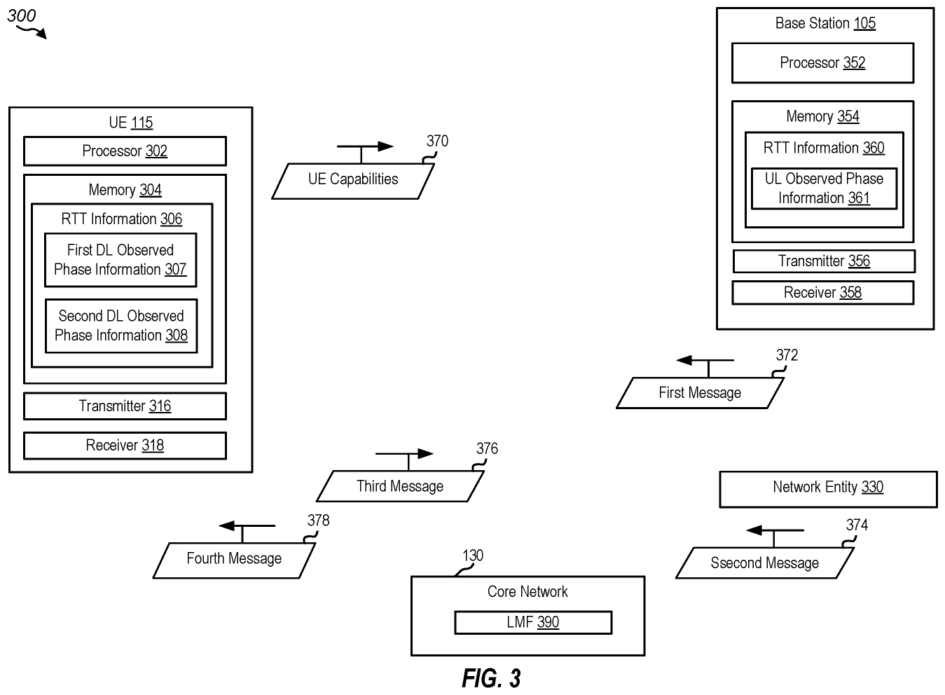

FIG. 3 is a block diagram of an example wireless communications system 300 that supports RTT for NR according to one or more aspects. In some examples, wireless communications system 300 may implement aspects of wireless network 100. Wireless communications system 300 includes UE 115, base station 105 (e.g., a gNB), a network entity 330, and core network 130. Although one UE 115, one base station 105, and one network entity 330 are illustrated, in some other implementations, wireless communications system 300 may generally include multiple UEs 115, more than one base station 105, more than one network entity 330, or a combination thereof. In some implementations, UEs (e.g., 115), base stations (e.g., 105), may be referred to as a network entity or a transmission/reception point (TRP).

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. For example, memory 304 may include processor-readable code that, when executed by processor 302, causes processor 302 to preform one or more of the operations described herein. In some implementations, processor 302 includes or corresponds to one or more of receive processor 258, transmit processor 264, and controller 280, and memory 304 includes or corresponds to memory 282.

Memory 304 includes or is configured to store RTT information 306. RTT information 306 may include information associated with one or more RTT operations. The one or more operations may include a first RTT operation performed in association with UE 115 and another device, such as base station 105, network entity 330, another UE, as illustrative, non-limiting examples. The one or more operations also may include a second RTT operation performed in association with UE 115 and another device, such as base station 105, network entity 330, or another UE, as illustrative, non-limiting examples.

In some implementations, RTT information 306 may include, for each of the one or more RTT operations, downlink (DL) phase information, uplink (UL) phase information, a DL carrier frequency, and a UL carrier frequency. To illustrate, RTT information 306 may include first DL observed phase information 307 associated with a first RTT operation and second DL observed phase information 308 associated with a second RTT operation.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2. In some implementations, transmitter 316, receiver 318, or a combination thereof may be referred to as an interface that is configured for wired communication, wireless communication, or a combination thereof.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. For example, memory 354 may include processor-readable code that, when executed by processor 352, causes processor 352 to preform one or more of the operations described herein. In some implementations, processor 352 includes or corresponds to one or more of receive processor 238, transmit processor 220, and controller 240, and memory 354 includes or corresponds to memory 242.

Memory 354 includes or is configured to store RTT information 360. RTT information 360 may include information associated with one or more RTT operations. In some implementations, RTT information 306 may include, for each of the one or more RTT operations, downlink (DL) phase information, uplink (UL) phase information, a DL carrier frequency, and a UL carrier frequency. The one or more operations may include a first RTT operation performed in association with base station 105 and UE 115. RTT information associated with the first RTT operation may include uplink (UL) observed phase information 361. The one or more operations also may include a second RTT operation performed in association with base station 105 and another device, such as UE 115, network entity 330, or another UE, as illustrative, non-limiting examples.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2. In some implementations, transmitter 356, receiver 358, or a combination thereof may be referred to as an interface that is configured for wired communication, wireless communication, or a combination thereof.

Network entity 330 may include or correspond to UE 115, base station 105, or another device, such as an Internet-of-Things (IoT) device. Accordingly, network entity 330 may include one or more components described herein with reference to UE 115, base station 105, or a combination thereof. Additionally, or alternatively, network entity 330 may be configured to perform one or more operations described herein with reference to UE 115, base station 105, or a combination thereof.

Core network 130 may include a 4G core network, a 5G core, an evolved packet core (EPC). Core network may be coupled, such as communicatively coupled, to base station 105, UE 115, or both. Core network 130 may include or correspond to LMF 390. Although shown and described as being included in core network 130, LMF 390 may be distinct from core network 130 in some implementations. For example the LMF 390 may include one or more servers, such as multiple distributed servers. LMF 390 may be configured to support various functionality, such as managing support for different location services for one or more UEs. For example, LMF 390 is configured to control the positioning parameters for UEs 115 and the LMF 390 can provide information to the base stations 105 and UE 115 so that action can be taken at UE 115. Base stations 105 may forward location messages to the LMF 390 and may communicate with the LMF 390 via a NR Positioning Protocol A (NRPPa). In some implementations, UE 115 and base station 105 are configured to communicate with the LMF 390 via an Access and Mobility Management Function (AMF).

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

NR supports timing-based positioning methods for both synchronized and unsynchronized networks. For example, downlink time difference of arrival (DL-TDOA) or uplink time difference of arrival (UL-TDOA) may be used for synchronized networks, and multi-RTT (multi-Round Trip Time (RTT)) may be used for unsynchronized networks. As described herein, carrier phase methods are applied to positioning methods in unsynchronized networks. For example, positioning of UE 115 in an unsynchronized network may be determined using carrier phase for RTT, such as an NR carrier phase for multi-RTT.

Carrier phase for RTT may include UE 115 performing an RTT operation with another device, such as a gNB (e.g., base station 105), another UE, an IoT device, or another device. For ease of explanation, the carrier phase for RTT is described with referent to an RTT operation between UE 115 and a gNB. Each of the gNB and UE 115 are configured to maintain internal carrier phase for a period of time. For example, each of the gNB and UE 115 may be configured to maintain internal carrier phase during a Time Division Duplex (TDD) switch, such as an NR TDD operation, performed during the RTT operation. To illustrate, the gNB may receive an uplink signal and may maintain an internal phase during a TDD switch performed at gNB. Additionally, UE 115 may receive a downlink signal and may maintain an internal phase during a TDD switch performed at UE 115.

In some implementations a device, such as UE 115, gNB (e.g., base station 105), or network entity 330, is configured to indicate or transmit one or more capabilities. For example, the device may be configured to transmit capability information that includes or indicates a band, a band combination, a carrier aggregation (CA) combination, or a combination thereof available for carrier phase reporting, an ability to maintain a phase during a TDD switch from UL to DL, an ability to maintain a phase during a TDD switch from DL to UL, a duration (e.g., a time period or a number of slots) the phase is able to be maintained during the TTD switch, or a combination thereof. Additionally or alternatively, the capability information may indicate whether each band/band combination or carrier aggregation (CA) combination is feasible for carrier phase reporting. Capability information of a device may be provided to one or more other device to core network 130, such as LMF 390, or a combination thereof.

Additionally, to apply carrier phase for RTT, it is assumed that group delays have been measured and corrected. A group delay may be associated with a propagation delay of signal via one or more components of a device. For example, UE 115 may include a first group delay associated with a transmit chain (e.g., one or more components in a transmission path) of UE 115, a second delay associated with a receive chain (e.g., one or more components in a reception path) of UE 115, or a combination thereof. As another example, a gNB may include a third group delay associated with a transmit chain (e.g., one or more components in a transmission path) of the gNB, a fourth delay associated with a receive chain (e.g., one or more components in a reception path) of the gNB, or a combination thereof. In some implementations, a group delay is considered a fixed amount of time.

To explain and establish a carrier phase method adopted for unsynchronized networks, the following terms (variables) are defined: PR=pseudo range, ϕ=carrier phase, θ=observed phase at Rx, θ_{gNB}^{init}=initial phase at gNB, dt_{gNB}−dT_{UE}=clock offset between gNB and UE, and w=measurement noise. Additionally, τ_{gNBTx}, τ_{UERx}, τ_{UETx}, τ_{gNBRx} are group delays, and λ^{D}, λ^{U} are DL and UL carrier frequencies, respectively. Further, d may be a distance between the gNB and UE 115, c is the speed of light, and Nis an integer number of a wavelength and may be referred to as a “cycle ambiguity”. Additionally, the superscript D denotes downlink and the superscript U denotes uplink.

It is noted that RTT can have different DL and UL carrier frequencies as they can be configured independently. In some implementations, it may be assumed that a center frequency is the center of the configured positioning frequency layer (PFL) or bandwidth (BW). Additionally, or alternatively, in some implementations, it may be assumed that λ^{D}=λ^{U}.

A measurement model for RTT between the gNB and UE 115 may include or be based on a set of equations. For example, the set of equations may include:

a downlink pseudo range equation:

$${PR}_{1}^{D} = {d}_{1} + c ( {dt}_{gNB} - {dT}_{UE} ) + c ( {τ}_{gNBTx} + {τ}_{UERx} ) + {w}_{PR 1}^{D} ;$$

an uplink pseudo range equation:

$${PR}_{1}^{U} = {d}_{1} - c ( {dt}_{gNB} - {dT}_{UE} ) + c ( {τ}_{UETx} + {τ}_{gNBRx} ) + {w}_{PR 2}^{U} ;$$

a downlink carrier phase equation:

$${ϕ}_{1}^{D} = \frac{λ}{2 π} ( {θ}_{1}^{D} - {θ}_{gNB}^{init} - 2 π {N}_{1}^{D} ) = {PR}_{1}^{D} - {λ}^{D} {N}_{1}^{D} + {w}_{{ϕ}_{1}}^{D} ;$$

an uplink carrier phase equation:

$${ϕ}_{1}^{U} = \frac{λ}{2 π} ( {θ}_{1}^{U} + {θ}_{gNB}^{init} - 2 π {N}_{1}^{U} ) = {PR}_{1}^{U} - {λ}^{U} {N}_{1}^{U} + {w}_{{ϕ}_{1}}^{U} .$$

It is noted that it may be assumed that initial phase θ_{gNB}^{init} for DL and UL carrier phase measurement is the same, which is based on an assumption that the phase is consistent even with a TDD switch. The distance between UE 115 and gNB may correspond to an integer number of a wavelength of a signal and some fractional portion of the wavelength of the signal.

The set of equations may be combined to generate a second of measurement processing equations. For example, the downlink pseudo range equation and the uplink pseudo range equation may be set equal to each other. As another example, the uplink carrier phase equation and the downlink carrier phase equation may be set equal to each other. The measurement processing equation may include:

$${\hat{d}}_{1} = \frac{{PR}_{1}^{D} + {PR}_{1}^{U}}{2} = {d}_{1} + \frac{( {w}_{{PR}_{1}}^{D} + {w}_{{PR}_{2}}^{D} )}{2} ; and$$

$${\hat{ϕ}}_{1} = \frac{{ϕ}_{1}^{D} + {ϕ}_{1}^{U}}{2} = {d}_{1} - \frac{( {λ}^{D} {N}_{1}^{D} + {λ}^{U} {N}_{1}^{U} )}{2} + \frac{{w}_{{ϕ}_{1}}^{D} + {w}_{{ϕ}_{1}}^{U}}{2} .$$

It is noted that the distance in an uplink direction and the distance in the downlink direction are the same distance irrespective of whether or not λ^{D}=λ^{U}. Stated differently, Irrespective of how many number of cycles (e.g., an integer number of cycles and a fractional portion of a cycle) are in the downlink (e.g., λ^{D}) or the uplink (e.g., λ^{U}), the distance d is the same. Thus, the distance between UE 115 and the gNB may be equal to each of

$${λ}^{D} ( {N}_{1}^{D} + \frac{{θ}_{1}^{D}}{2 π} )$$

and

$${λ}^{U} ( {N}_{1}^{U} + \frac{{θ}_{1}^{U}}{2 π} ) .$$

A constraint of the distance between the represented by the following equation:

$$\vert {λ}^{D} {N}_{1}^{D} - {λ}^{U} {N}_{1}^{U} \vert < \vert ( {λ}^{D} - {λ}^{U} ) \vert .$$

Alternatively, the constraint may be written as:

$$\vert {λ}^{D} {N}_{1}^{D} - {λ}^{U} {N}_{1}^{U} \vert \leq \vert ( {λ}^{D} - {λ}^{U} ) \vert .$$

Further, given that the distance between UE 115 and the gNB may be equal to each of

$${λ}^{D} ( {N}_{1}^{D} + \frac{{θ}_{1}^{D}}{2 π} )$$

and

$${λ}^{U} ( {N}_{1}^{U} + \frac{{θ}_{1}^{U}}{2 π} ) ,$$

a constraint equation may include:

$${λ}^{D} ( {N}_{1}^{D} + \frac{{θ}_{1}^{D}}{2 π} ) = {λ}^{U} ( {N}_{1}^{U} + \frac{{θ}_{1}^{U}}{2 π} ) .$$

In constraint

$${λ}^{D} ( {N}_{1}^{D} + \frac{{θ}_{1}^{D}}{2 π} ) = {λ}^{U} ( {N}_{1}^{U} + \frac{{θ}_{1}^{U}}{2 π} ) ,$$

$${λ}^{D} ( {N}_{1}^{D} + \frac{{θ}_{1}^{D}}{2 π} )$$

may be referred to as a first condition and

$${λ}^{U} ( {N}_{1}^{U} + \frac{{θ}_{1}^{U}}{2 π} )$$

may be referred to as a second condition. If λ^{U} and λ^{D} are known, and if θ₁^{D} and θ₁^{U} are able to be measured by UE 115 and gNB, the values of N₁^{U} and N₁^{D} may be solved for that satisfy the constraint.

The constraint may be used to implement a carrier phase methods in NR for an RTT method, such as a multi-RTT method. For example, the constraint may be applied to each RTT operation of multiple RTT operations to determine a set of N₁^{U} and N₁^{D} that satisfy the constraint for the RTT. Each set of set of N₁^{U} and N₁^{D} that satisfy the constraint for the RTT may correspond to a different distance, such as a candidate distance. The candidate distances associated with multiple RTT operations may be used to determine a position of UE 115. To determine the position of UE 115, a search operation should multiple (or all) pairs of N^{D}, N^{U} which satisfy the constraint. The above technique may be signed to reduce errors if the wavelengths, i.e., λ^{U} and λ^{D}, are different. However, in some situations, such as if the wavelengths are too far apart (such as when different carriers are transmitted or received using different hardware), then θ_{gNB}^{init} is not the same in DL and UL and a large error may occur.

In some implementations, the position may be determined by UE 115. That is, UE 115 may receive, for each RTT, λ^{U}, λ^{D}, θ₁^{D}, and θ₁^{U} and may use the constraint to determine the position of UE 115. For example, UE 115 may measure DL carrier phase θ₁^{D} and report the measured DL carrier phase θ₁^{D} to LMF 390. Additionally, or alternatively, UE 115 may report other RTT metrics such as λ^{U}, λ^{D}, or a combination thereof. A gNB, or network entity or transmission/reception point (TRP) that performs an RTT with UE 115, may measure UL carrier phase θ₁^{U} and report the measured UL carrier phase θ₁^{U} to LMF 390. Additionally, or alternatively, the gNB (e.g., the network entity or the TRP) may report other RTT metrics such as λ^{U}, λ^{D}, or a combination thereof. It is noted that independent reporting of carrier phase for each positioning reference signal (PRS)/souring reference signal (SRS) resource, for each Rx beam, or a combination thereof, may be enabled.

In other implementations, a network device, such as core network 130 or LMF 390, may receive, for each RTT, λ^{U}, λ^{D}, θ₁^{D}, and θ₁^{U} and may use the constraint to determine the position of UE 115. To illustrate, A gNB, or network entity or transmission/reception point (TRP) that performs an RTT with UE 115, may measure UL carrier phase OB and report the measured UL carrier phase θ₁^{U} to LMF 390. LMF 390 may forward the received information to UE 115. In some implementations, both UE 115 and the network entity may determine the position of UE 115. In some implementations, the multi-RTT may be used between multiple devices for side link (SL) positioning.

During operation of wireless communications system 300, UE 115 may transmit UE capabilities 370. is configured to perform one or more operations. UE capabilities 370 may include or indicate a band, a band combination, a carrier aggregation (CA) combination, or a combination thereof available for carrier phase reporting, an ability to maintain a phase during a time division duplex (TDD) switch, a duration the phase is able to be maintained during the TTD switch, or a combination thereof.

One or more RTT operations may be scheduled for UE 115. For example, a first RTT operation may be scheduled for UE 115 and base station 105, and a second RTT operation may be scheduled for UE 115 and network entity 330. In some implementations, the one or more operations may be scheduled based on UE capabilities, capabilities of another device (e.g., base station 105 or network entity 330), or a combination thereof. Additionally, or alternatively, the one or more RTT operations may be scheduled by UE 115, by core network 130, LMF 390, or another device (e.g., base station 105 or network entity 330).

Each scheduled RTT operation may be associated with a corresponding DL carrier frequency, and a corresponding UL carrier frequency. For example, the first RTT operation may be associated with a first DL carrier frequency and a first UL carrier frequency, and the second RTT operation may be associated with a second DL carrier frequency and a second UL carrier frequency.

UE 115 may perform the first RTT operation with base station 105. In some implementations, each of UE 115 and base station 105 is configured to maintain a phase during a TDD switch. Based on the first RTT operation, UE 115 may determine first DL observed phase information 307 (referred to herein as “first DL phase information 307”) and base station 105 may determine UL observed phase information 361 (referred to herein as “first UL phase information 361”). First RTT information associated with the first RTT operation may include or indicate the first DL carrier frequency, the first UL carrier frequency, first DL phase information 307, first UL phase information 361, or a combination thereof.

UE 115 may perform the second RTT operation with network entity 330. In some implementations, each of UE 115 and network entity 330 is configured to maintain a phase during a TDD switch. Based on the second RTT operation, UE 115 may determine second DL observed phase information 308 (referred to herein as “second DL phase information 308”) and network entity 330 may determine UL observed phase information (referred to herein as “second UL phase information”). Second RTT information associated with the second RTT operation may include or indicate the second DL carrier frequency, the second UL carrier frequency, second DL phase information 308, the second UL phase information, or a combination thereof.

Base station 105 may send a first message 372 to core network 130 and first message 372 may include or indicate first UL phase information 361. Additionally, or alternatively, first message 372 may include or indicate the first DL carrier frequency, the first UL carrier frequency, or a combination thereof. Core network 130 may provide first message 372 or first UL phase information 361 to LMF 390. In some implementations, base station 105 may transmit first message 372 to UE 115.

Network entity 330 may send a second message 374 to core network 130 and second message 374 may include or indicate the second UL phase information. Additionally, or alternatively, second message 374 may include or indicate the second DL carrier frequency, the second UL carrier frequency, or a combination thereof. Core network 130 may provide second message 374 or the second UL phase information to LMF 390. In some implementations, base station 105 may transmit first message 372 to UE 115.

In some implementations, UE 115 may transmit a third message 376 to core network 130. Third message 376 may include or indicate first DL phase information 307, second DL phase information, or a combination thereof. Additionally, or alternatively, third message 376 may include or indicate the first DL carrier frequency, the first UL carrier frequency, the second DL carrier frequency, the second UL carrier frequency, or a combination thereof. Core network 130 may provide third message 376, first DL phase information 307, or second DL phase information to LMF 390.

Core network 130, or LMF 390, may transmit a fourth message 378 to UE 115. In some implementations, core network or LMF 390 is configured to determine a position of UE 115 based on the first RTT information associated with the first RTT operation and the second RTT information associated with the second RTT operation. For example, LMF 390 may determine a constraint for each RTT operation and, for each constraint, may determine a set of one or more candidate distances. In some such implementations, fourth message 378 includes or indicates a position of UE 115. Additionally, or alternatively, in some implementations, UE 115 determines the position of UE 115 based on the first RTT information associated with the first RTT operation and the second RTT information associated with the second RTT operation. In some such implementations, core network 130 or LMF 390 transmits fourth message 378 to UE 115 and fourth message includes first UL phase information 361, the second UL phase information, or a combination thereof. UE 115 determines the position of UE 115 based on the first RTT information associated with the first RTT operation and the second RTT information associated with the second RTT operation. For example, UE 115 may determine a constraint for each RTT operation and, for each constraint, may determine a set of one or more candidate distances.

In some implementations, a device, such as UE 115 or LMF 390, that determines the position of UE 115 may perform one or more operations to determine, for each constraint, a set of DL and UL parameters that satisfy the constraint, and may perform one or more operations to search the set of DL and UL parameters to determine the position of UE 115. For example, the device may determine, for each RTT operation, a corresponding constraint based on the RTT information associated with the RTT operation. To illustrate, a first constraint associated with the first RTT operation may include a relationship between a first condition and a second condition. For example, the first condition may be a wavelength of the first DL carrier frequency multiplied by a sum of a DL parameter and a first fractional wavelength value, where the first fractional wavelength value based on first DL phase information 307. The second condition may be based on a wavelength of the first UL carrier frequency multiplied by a sum of an UL parameter and a second fractional wavelength value, the second fractional wavelength value based on first UL phase information 361. The DL parameter may include a DL cycle ambiguity and the UL parameter may include a UL cycle ambiguity. In some implementations, the DL parameter includes a first integer value that represents a first number of wavelengths associated with the first DL carrier frequency, and the UL parameter includes a second integer value that represents a second number of wavelengths associated with the first UL carrier frequency.

The device may determine, for the first constraint associated with the first RTT operation, a set of candidate values for the DL parameter and the UL parameter that satisfy the constraint associated with the first RTT information. The set of candidate values may include one or more candidate pairs of DL and UL parameters that satisfy the first constraint. Each set of candidate values for the first constraint may be associated with a candidate distance between UE 115 and base station 105 corresponding to the first RTT operation. Additionally, the device may determine other sets of candidate values for other RTT operations performed with UE 115 and other network entities, such as network entity 330. Based on the sets of candidate values for multiple RTT operations, the device may determine the position associated with the UE 115.

In some implementations, UE 115 may be configured to generate first DL phase information 307 based on the first RTT associated with a first network entity (e.g., base station 105); generate second DL phase information 308 based on the second RTT associated with a second network entity (e.g., 330); and obtain the position associated with UE 115 based on first DL phase information 307 and second DL phase information 308. Additionally, or alternatively, UE 115 may be configured to perform one or more operations as describe with reference to FIG. 7 or the appended claims.

Additionally, a network entity, such as UE 115, base station 105, core network 130, or LMF 390, may be configured to perform one or more operations. For example, the network entity may be configured to receive multiple sets of RTT information associated with UE 115, each RTT information of the multiple sets of RTT information associated with a different network entity, and determine the position associated with UE 115 based on the multiple sets of RTT information. In some implementations, each set of RTT information includes phase information, such as DL phase information associated with a RTT operation, UL phase information associated with the RTT operation, or a combination thereof. Additionally, or alternatively, LMF 390 may be configured to perform one or more operations as describe with reference to FIG. 9 or the appended claims.

As described with reference to FIG. 1, the present disclosure provides techniques for use of carrier phase in NR for multi-RTT to determine position information of a device included in a network, such as an asynchronous network. Additionally, the techniques may improve position accuracy, reduce overhead communication, and improve system efficiency.

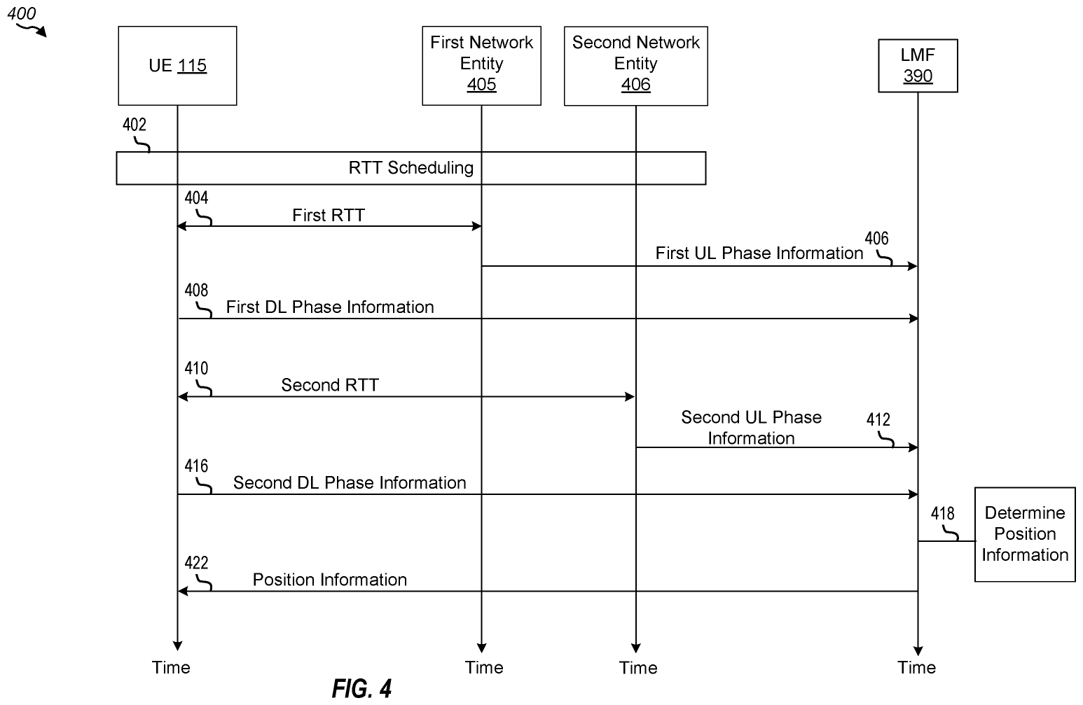

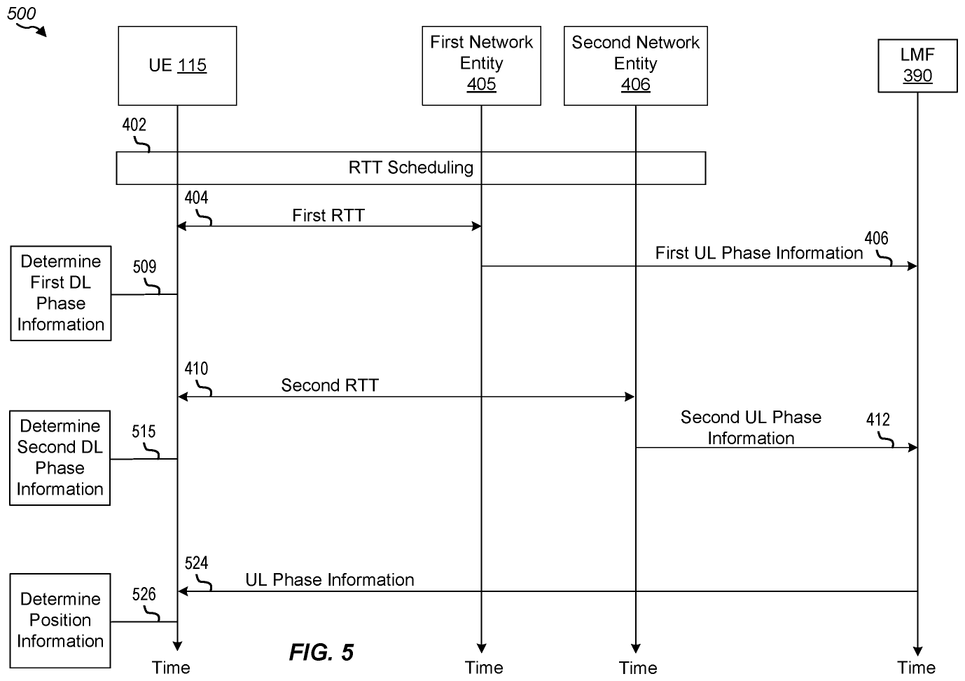

FIGS. 4 and 5 are ladder diagrams each illustrating examples of wireless communication systems that supports RTT for NR according to aspects of the present disclosure. For example, FIG. 4 shows a system 400 and FIG. 5 shows a system 500. System 400 and system 500 may include or correspond to wireless network 100 or wireless communications system 300.

As shown in FIGS. 4 and 5, a system of the ladder diagram includes UE 115, a first network entity 405, a second network entity 406, and an LMF 390. Each of first network entity 405 and second network entity 406 may include or correspond to base station 105, network entity 330, a UE (e.g., 115), or another device. LMF 390 may include or correspond to core network 130. UE 115, first network entity 405, second network entity 406, and LMF 390 may include one or more components and be configured to perform one or more operations, as described with reference to FIGS. 1-3.

Referring to FIG. 4, during operation, at 402, UE 115, first network entity 405, and second network entity 406 engage in RTT scheduling. The RTT scheduling, such as scheduling information, may include a first RTT scheduling associated with UE 115 and first network entity 405, and a second RTT scheduling associated with UE 115 and second network entity 406.

The first RTT scheduling may be scheduled by UE 115 or first network entity 405. The first RTT scheduling may include or indicate a first DL carrier frequency and a first UL carrier frequency. The first DL carrier frequency and the first UL carrier frequency are associated with a positioning reference signal (PRS) or a sounding reference signal (SRS). The first DL carrier frequency and the first UL carrier frequency may have different bandwidths, may have the same center frequency, or a combination thereof. In some implementations, the center frequency of the first DL carrier frequency is a the center of a configured positioning frequency layer (PFL) or a bandwidth (BW).

The second RTT scheduling may be scheduled by UE 115 or second network entity 406. The second RTT scheduling may include or indicate a second DL carrier frequency and a second UL carrier frequency. The second DL carrier frequency and the second UL carrier frequency are associated with a PRS or an SRS. In some implementations, the first RTT scheduling, the second RTT scheduling, or a combination there of may be communicated to or scheduled by LMF 390.

In some implementations, the first RTT scheduling and the second RTT scheduling may be scheduled using separate messaging. In some other implementations, the first RTT scheduling and the second RTT scheduling may be scheduled using the same messaging. Additionally, or alternatively, the RTT scheduling 402 may include communicating the RTT scheduling to LMF 390. Additionally, or alternatively, prior to the RTT scheduling, UE 115, first network entity 405, second network entity 406, or a combination thereof, may exchange capability information. For example, the capability information may include or indicate a band, a band combination, a CA combination, or a combination thereof available for carrier phase reporting, an ability to maintain a phase during a TDD switch, a duration the phase is able to be maintained during the TTD switch, or a combination thereof.

At 404, UE 115 and first network entity 405 perform a first RTT operation. Based on the first RTT operation, first network entity 405 determines first UL phase information, UE 115 determines first DL phase information, or a combination thereof. At 406, first network entity 405 transmits the first UL phase information to LMF 390. The first UL phase information may include or correspond to UL observed phase information 361, first RTT information, or a combination thereof. At 408, UE 115 transmits the first DL phase information to LMF 390. The first DL phase information may include or correspond to first DL observed phase information 307. In some implementations, UE 115 transmits the first DL phase information to LMF 390 via first network entity 405 or a base station, such as base station 105.

At 410, UE 115 and second network entity 406 perform a second RTT operation. Based on the second RTT operation, second network entity 406 determines second UL phase information, UE 115 determines second DL phase information, or a combination thereof. At 412, second network entity 406 transmits the second UL phase information to LMF 390. The second UL phase information may include or correspond to second RTT information. At 416, UE 115 transmits the second DL phase information to LMF 390. The second DL phase information may include or correspond to second DL observed phase information 308. In some implementations, UE 115 transmits the second DL phase information to LMF 390 via first network entity 405, second network entity 406, or a base station, such as base station 105.

At 418, LMF 390 determines position information associated with UE 115, such as a position (e.g., location) of UE 115. For example, LMF 390 may perform one or more operations as described with reference to FIG. 3. To illustrate, LMF 390 may determine the position information based on the first UL phase information, the first DL phase information, the second UL phase information, the second DL phase information, or a combination thereof. In some implementations, LMF 390 may further determine the position information base on the first DL carrier frequency associated with the first RTT, the first UL carrier frequency associated with the first RTT, the second DL carrier frequency associated with the second RTT, the second UL carrier frequency associated with the second RTT, or a combination thereof. At 422, LMF transmits the position information to UE 115.

Referring to FIG. 5, one or more operations of FIG. 5 may be the same as described with reference to FIG. 4. For example, during operation, at 402, UE 115, first network entity 405, and second network entity 406 engage in RTT scheduling.

At 404, UE 115 and first network entity 405 perform a first RTT operation. Based on the first RTT operation, first network entity 405 determines first UL phase information. At 406, first network entity 405 transmits the first UL phase information to LMF 390. At 509, UE 115 determines first DL phase information.

At 410, UE 115 and second network entity 406 perform a second RTT operation. Based on the second RTT operation, second network entity 406 determines second UL phase information. At 412, second network entity 406 transmits the second UL phase information to LMF 390. At 515, UE 115 determines second DL phase information, or a combination thereof.

At 524, LMF 390 transmits UL phase information to UE 115. The UL phase information may include or correspond to the first UL phase information, second UL phase information, or a combination thereof.

At 526, UE 115 determines position information associated with UE 115, such as a position (e.g., location) of UE 115. For example, UE 115 may perform one or more operations as described with reference to FIG. 3. To illustrate, UE 115 may determine the position information based on the UL phase information from LMF 390, the first DL phase information, the second DL phase information, or a combination thereof. For example, UE 115 may determine the position information based on the first UL phase information, the first DL phase information, the second UL phase information, the second DL phase information, or a combination thereof. In some implementations, LMF 390 may further determine the position information base on the first DL carrier frequency associated with the first RTT, the first UL carrier frequency associated with the first RTT, the second DL carrier frequency associated with the second RTT, the second UL carrier frequency associated with the second RTT, or a combination thereof. At 422, LMF transmits the position information to UE 115.

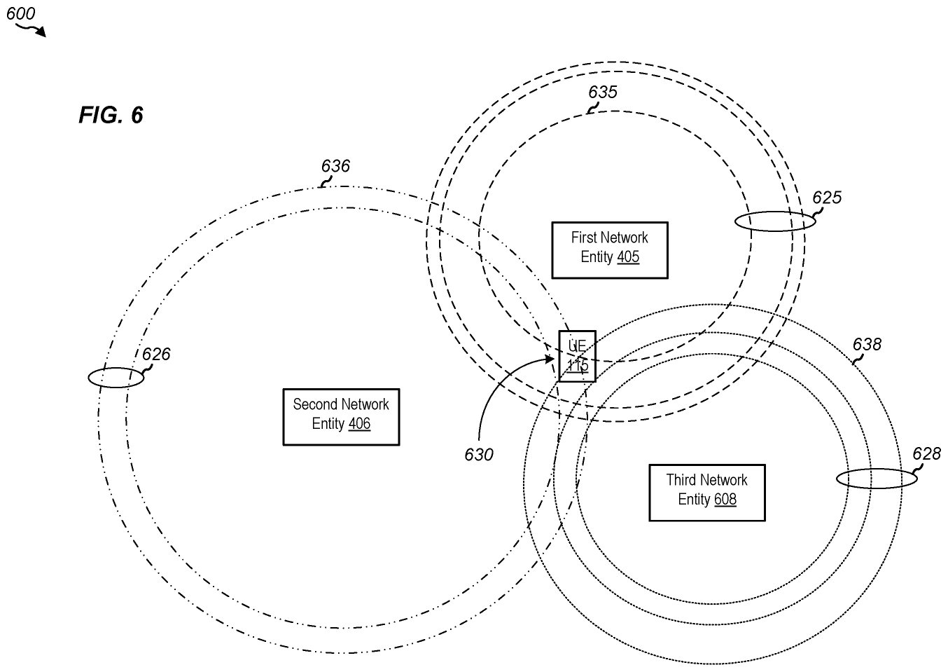

FIG. 6 is a block diagram illustrating details of an example wireless communication system according to one or more aspects. As shown in FIG. 6, a system 600 includes UE 115, first network entity 405, second network entity 406, and a third network entity 608. Third network entity 608 may include or correspond to base station 105, network entity 330, a UE (e.g., 115), or another device. FIG. 6 illustrates candidate distances based on RTT operations associated with UE 115 and each of first network entity 405, second network entity 406, and third network entity 608.

The candidate distances may include a first set of candidate distances 625, a second set of candidate distances 626, and a third set of candidates distance. First set of candidate distances 625 is associated with one or more first distances between first network entity 405 and UE 115. For example, first set of candidate distances 625 may include a representative first distance 635. First set of candidate distances 625 may be determined based on a first RTT operation performed between UE 115 and first network entity 405. Each distance of first set of candidate distances 625 may be associated with or correspond to a first set of candidate values for a first DL parameter and a first UL parameter that satisfy a first constraint associated with the first RTT operation. The first constraint may include or correspond to a constraint as described herein at least with reference to FIG. 3, 7, or 9. First set of candidate distances 625 may be determined by UE 115, a network entity, a core network (e.g., 130), an LMF (e.g., 390), or a combination thereof.

Second set of candidate distances 626 is associated with one or more second distances between second network entity 406 and UE 115. For example, second set of candidate distances 626 may include a representative second distance 636. Second set of candidate distances 626 may be determined based on a second RTT operation performed between UE 115 and second network entity 406. Each distance of second set of candidate distances 626 may be associated with or correspond to a second set of candidate values for a second DL parameter and a second UL parameter that satisfy a second constraint associated with the second RTT operation. The second constraint may include or correspond to a constraint as described herein at least with reference to FIG. 3, 7, or 9. Second set of candidate distances 626 may be determined by UE 115, a network entity, a core network (e.g., 130), an LMF (e.g., 390), or a combination thereof.

Third set of candidate distances 628 is associated with one or more third distances between third network entity 408 and UE 115. For example, third set of candidate distances 628 may include a representative third distance 638. Third set of candidate distances 628 may be determined based on a third RTT operation performed between UE 115 and third network entity 408. Each distance of third set of candidate distances 628 may be associated with or correspond to a third set of candidate values for a third DL parameter and a third UL parameter that satisfy a third constraint associated with the third RTT operation. The third constraint may include or correspond to a constraint as described herein at least with reference to FIG. 3, 7, or 9. Third set of candidate distances 628 may be determined by UE 115, a network entity, a core network (e.g., 130), an LMF (e.g., 390), or a combination thereof.

A position, such as location 630, of UE 115 may be determined based on one or more location techniques, such as triangulation, as an illustrative, non-limiting example. For example, if a location of first network entity 405, second network entity 406, and third network entity 608 is known, the position of UE 115 may be determined based on an intersection, or approximate or substantial intersection, of a first distance of first set of candidate distance 625, a second distance of second set of candidate distance 626, and a third distance of third set of candidate distance 628. As shown in FIG. 6, first distance 635, second distance 636, and third distance 638 intersect at location 630. The position, such as location 630, of UE 115 may be determined by determined by UE 115, a network entity, a core network (e.g., 130), an LMF (e.g., 390), or a combination thereof.

FIG. 7 is a flow diagram illustrating an example process 700 that supports RTT for NR according to one or more aspects. Operations of process 700 may be performed by a UE, such as UE 115 described above with reference to FIGS. 1-6, or a UE described with reference to FIG. 8. For example, example operations (also referred to as “blocks”) of process 700 may enable UE 115 to support RTT for NR.

In block 702, the UE generates first DL phase information based on a first round trip time (RTT) associated with a first network entity. The first DL phase information may include or correspond to first DL observed phase information 307. In some implementations, the first DL phase information includes an observed phase measured based on a downlink signal received via a receive component of the UE. The DL phase information may include a phase average of the observed phase. The first network entity may include or correspond to base station 105, first network entity 405, or another device. Additionally, or alternatively, the first RTT may include an NR RTT.

In some implementations, the UE performs the first RTT with the first network entity. The first RTT may be associated with a first DL carrier frequency and a first UL carrier frequency. The first DL carrier frequency and the first UL carrier frequency may be associated with a PRS or an SRS. In some implementations, the UE transmits an indicator of the first DL carrier frequency, the first UL carrier frequency, or a combination thereof to a core network or an LMF. Additionally, or alternatively, the first DL carrier frequency and the first UL carrier frequency may have different bandwidths, the first DL carrier frequency and the first UL carrier frequency may have the same center frequency, or a combination thereof. In some implementations, the center frequency of the first DL carrier frequency is a the center of a configured PFL or a BW.

In block 704, the UE generates second DL phase information based on a second RTT associated with a second network entity. The second DL phase information may include or correspond to second DL observed phase information 308. The second network entity may include or correspond to network entity 330, second network entity 406, or another device. In some implementations, the UE performs the second RTT with the second network entity. The second RTT may be associated with a second DL carrier frequency and a second UL carrier frequency.

In some implementations, the UE, the first network entity, and the second network entity are included in an asynchronous network. Additionally, or alternatively, is some implementations, the first network entity includes a first base station, the second network entity includes a second base station, or a combination thereof. In some implementations, the first RTT and the second RTT are associated with side link (SL) positioning operations.

In some implementations, the UE performs a third RTT with a third network entity. The third network entity may include or correspond to network entity 608. The third RTT may be associated with a third DL carrier frequency and a third UL carrier frequency. The UE also may generate third DL phase information based on the third RTT associated with the third network entity.

In block 706, the UE obtains a position associated with the UE based on the first DL phase information and the second DL phase information. In some implementations, the position is a position of the UE. Additionally, or alternatively, the position may be determined based on the third DL phase information.

In some implementations, the UE maintains an internal carrier phase during at least a first portion of the first RTT. Additionally, the UE may perform a TDD switch during the first RTT, such as during the first portion of the first RTT. Additionally, or alternatively, the first network entity may be configured to maintain an internal carrier phase during at least a second portion of the first RTT. Additionally, the first network entity may be configured to perform a TDD switch during the first RTT, such as during the second portion of the first RTT.

In some implementations, the UE may transmit UE capability information, such as prior to scheduling or performing the first RTT, the second RTT, or both. The UE capability information may indicate a band, a band combination, a carrier aggregation (CA) combination, or a combination thereof available for carrier phase reporting, an ability to maintain a phase during a time division duplex (TDD) switch, a duration the phase is able to be maintained during the TTD switch, or a combination thereof, as illustrative, non-limiting examples. In some implementations, the UE may receive capability information from the first network entity. The capability information received from the first network entity may be associated with the first RTT. For example, the capability information of the first network entity may be used to schedule or perform the first RTT. In some implementations, the UE determine scheduling information associated with the first RTT. For example, the UE may determine the scheduling information based on the UE capability information, the capability information of the first network entity, or a combination thereof.

In some implementations, the UE transmits the first DL phase information to an LMF, such as LMF 390. Additionally, or alternatively, the UE may transmit the second DL phase information to the LMF. In some implementations, the UE obtains the position by receiving position information from the LMF.

In some implementations, the UE receives first UL phase information based on the first RTT. The first UL phase information may be determined by the first network entity. Additionally, or alternatively, the UE may receive second UL phase information based on the second RTT. The second UL phase information may be determined by the second network entity. In some implementations, the UE obtains the position by determining the position based on a first DL carrier frequency associated with the first RTT, a first UL carrier frequency associated with the first RTT, a second DL carrier frequency associated with the second RTT, a second UL carrier frequency associated with the second RTT, or a combination thereof.

In some implementations, the UE determines a first constraint based on first RTT information associated with the first RTT. The first RTT information may include or indicate the first DL phase information, the first UL phase information, a first DL carrier frequency associated with the first RTT, a first UL carrier frequency associated with the first RTT, a first DL parameter, a first UL parameter, or a combination thereof. The first DL parameter may include a first DL cycle ambiguity and the first UL parameter may include a first UL cycle ambiguity. Additionally, or alternatively, the first DL parameter may include a first integer value and the first UL parameter may include a second integer value. The first integer value may represent a first number of wavelength associated with the first DL carrier frequency, and the second integer value may represent a second number of wavelengths associated with the first UL carrier frequency.

Additionally, or alternatively, the UE may determine a second constraint based on second RTT information associated with the second RTT. The second RTT information may include or indicate the second DL phase information, the second UL phase information, a second DL carrier frequency associated with the second RTT, a second UL carrier frequency associated with the second RTT, a second DL parameter, a second UL parameter, or a combination thereof.

In some implementations, the first constraint is associated with a first condition that is less than or equal to a second condition. For example, the first condition may be based on a wavelength of the first DL carrier frequency multiplied by a sum of the first DL parameter and a first fractional wavelength value. Additionally, the first fractional wavelength value may be based on the first DL phase information. The second condition may be based on a wavelength of the first UL carrier frequency multiplied by a sum of the first UL parameter and a second fractional wavelength value. Additionally, the second fractional wavelength value based on the first UL phase information.

In some implementations, the UE determines a first set of candidate values for the first DL parameter and the first UL parameter that satisfy the first constraint. The first set of candidate values may include one or more candidate pairs of DL and UL parameters that satisfy the first constraint. Additionally, or alternatively, the UE may determine a second set of candidate values for the second DL parameter and the second UL parameter that satisfy the second constraint. The UE may determine the position associated with the UE based on the first set of candidate values, the second set of candidate values, or a combination thereof.

FIG. 8 is a block diagram of an example UE 800 that supports RTT for NR according to one or more aspects. UE 800 may be configured to perform operations, including the blocks of a process described with reference to FIG. 7. In some implementations, UE 800 includes the structure, hardware, and components shown and described with reference to UE 115 of FIGS. 1-3. For example, UE 800 includes controller 280, which operates to execute logic or computer instructions stored in memory 282, as well as controlling the components of UE 800 that provide the features and functionality of UE 800. UE 800, under control of controller 280, transmits and receives signals via wireless radios 801a-r and antennas 252a-r. Wireless radios 801a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include RTT logic 802, phase information 803, position information 804, and position logic 805. RTT logic 802 may be configured to perform one or more operations described herein with reference to UE 115, such as one or more RTT operations. For example, RTT logic 802 may be configured to generate first DL phase information based on a first RTT associated with a first network entity, generate second DL phase information based on a second RTT associated with a second network entity, or a combination thereof. Phase information 803 may include or correspond to RTT information 306. Position information 804 may include or indicate a position of UE 800. UE 800 may receive signals from or transmit signals to one or more network entities, such as base station 105 of FIGS. 1-3, core network 130, LMF 390, a TRP, another UE, or an IoT device.

FIG. 9 is a flow diagram illustrating an example process 900 that supports RTT for NR according to one or more aspects. Operations of process 900 may be performed by a network entity, such as a UE (e.g., 115), a base station (e.g., 105), core network 130 or LMF 390 described above with reference to FIG. 1, 3, or 4, or a network entity as described with reference to FIG. 10. For example, example operations of process 900 may enable the network entity to support RTT for NR.

At block 902, the network entity receives multiple sets of RTT information associated with a UE. The UE may include or correspond to UE 115 or UE 800. Each RTT information of the multiple sets of RTT information may be associated with a different network entity. Additionally, or alternatively, each RTT information of the multiple sets of RTT information may include DL phase information, UL phase information, a DL carrier frequency, a UL carrier frequency, or a combination thereof.

At block 904, the network entity determines a position associated with the UE based on the multiple sets of RTT information. In some implementations, the network entity may transmit an indicator that indicates the position.

In some implementations, the network entity determines, for each RTT information of the multiple sets of RTT information, a constraint. For each RTT information of the multiple sets of RTT information, the determined constraint may be determined based on the DL phase information, the UL phase information, the DL carrier frequency, the UL carrier frequency, a respective DL parameter, a respective UL parameter, or a combination thereof. For each RTT information of the multiple sets of RTT information, the DL parameter may include a DL cycle ambiguity and the UL parameter may include a UL cycle ambiguity. Additionally, or alternatively, for each RTT information of the multiple sets of RTT information, the DL parameter may include a first integer value and the UL parameter may include a second integer value. For each RTT information of the multiple sets of RTT information, the first integer value may represent a first number of wavelengths associated with the DL carrier frequency, and the second integer value may represent a second number of wavelengths associated with the UL carrier frequency.

In some implementations, for each RTT information of the multiple sets of RTT information, the determined constraint is associated with a first condition that is less than or equal to a second condition. For example, the first condition may be based on a wavelength of the DL carrier frequency multiplied by a sum of the DL parameter and a first fractional wavelength value. The first fractional wavelength value may be based on the DL phase information. As another example, the second condition may be based on a wavelength of the UL carrier frequency multiplied by a sum of the UL parameter and a second fractional wavelength value. The second fractional wavelength value may be based on the UL phase information.

In some implementations, for each RTT information of the multiple sets of RTT information, the network entity determines a set of candidate values for the DL parameter and the UL parameter that satisfy the constraint determined for the RTT information. For each RTT information of the multiple sets of RTT information, the set of candidate values may include one or more candidate pairs of DL and UL parameters that satisfy the constraint the RTT information. The network entity may determine the position associated with the UE based on the set of candidate values of each RTT information of the multiple sets of RTT information.

FIG. 10 is a block diagram of an example network entity 1000 that supports RTT for NR according to one or more aspects. Network entity 1000 may be configured to perform operations, including the blocks of process 900 described with reference to FIG. 9. In some implementations, network entity 1000 includes the structure, hardware, and components shown and described with reference to base station 105 of FIGS. 1-3, UE 115, core network 130, or LMF 390. For example, network entity 1000 may include controller 240, which operates to execute logic or computer instructions stored in memory 242, as well as controlling the components of network entity 1000 that provide the features and functionality of network entity 1000. Network entity 1000, under control of controller 240, transmits and receives signals via wireless radios 1001a-t and antennas 234a-t. Wireless radios 1001a-t include various components and hardware, as illustrated in FIG. 2 for base station 105, including modulator and demodulators 232a-t, transmit processor 220, TX MIMO processor 230, MIMO detector 236, and receive processor 238. Additionally, or alternatively, network entity 1000 may be configured for wired communication.

As shown, the memory 242 may include RTT logic 1002, phase information 1003, position information 1004, and position logic 1005. RTT logic 1002 may be configured to perform one or more operations described herein with reference to UE 115, base station 105, or network entity 330, such as one or more RTT operations. For example, RTT logic 1002 may be configured to generate first UL phase information based on a first RTT associated with UE 115 or UE 800. Phase information 1003 may include or correspond to RTT information 360. Position information 1004 may include or indicate a position of another network device, such as UE 115 or UE 800. Network entity 1000 may receive signals from or transmit signals to one or more UEs, such as UE 115 of FIGS. 1-3 or UE 800 of FIG. 8, base station 105 of FIGS. 1-3, or another network entity.

It is noted that one or more blocks (or operations) described with reference to FIGS. 7 and 9 may be combined with one or more blocks (or operations) described with reference to another of the figures. For example, one or more blocks (or operations) of FIG. 7 may be combined with one or more blocks (or operations) of FIG. 9. As another example, one or more blocks associated with FIG. 7 or 9 may be combined with one or more blocks (or operations) associated with FIGS. 1-6.

The following examples are illustrative only and may be combined with aspects of other implementation or teachings described herein, without limitation.

In some aspects, techniques for supporting RTT for NR may include additional aspects, such as any single aspect or any combination of aspects described below or in connection with one or more other processes or devices described elsewhere herein. In a first aspect, techniques for supporting RTT for NR may include generating first DL phase information based on a first RTT associated with a first network entity; generating second DL phase information based on a second RTT associated with a second network entity; and obtaining a position associated with a UE based on the first DL phase information and the second DL phase information. In some examples, the techniques in the first aspect may be implemented in a method or process. In some other examples, the techniques of the first aspect may be implemented in a wireless communication device such as a UE, a component of a UE, a network entity, or a component of a network entity. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a second aspect, in combination with the first aspect, the first DL phase information includes an observed phase measured based on a downlink signal received via a receive component of the UE.

In a third aspect, in combination with the second aspect, the first DL phase information includes a phase average of the observed phase.

In a fourth aspect, in combination with one or more of the first aspect through the third aspect, the RTT includes an NR RTT.

In a fifth aspect, in combination with one or more of the first aspect through the fourth aspect, the UE, the first network entity, and the second network entity are included in an asynchronous network.

In a sixth aspect, in combination with one or more of the first aspect through the fifth aspect, the first network entity includes a first base station; and the second network entity includes a second base station.

In a seventh aspect, in combination with one or more of the first aspect through the fifth aspect, the first RTT and the second RTT are associated with SL positioning operations.

In an eighth aspect, in combination with one or more of the first aspect through the seventh aspect, the techniques further include maintaining an internal carrier phase during at least a first portion of the first RTT.

In a ninth aspect, in combination with the eighth aspect, the techniques further include performing a TDD switch during the first RTT.

In a tenth aspect, in combination with the ninth aspect, the TDD switch is performed during the first portion of the first RTT.

In an eleventh aspect, in combination with one or more of the first aspect through the tenth aspect, the first network entity is configured to maintain an internal carrier phase during at least a second portion of the first RTT.

In a twelfth aspect, in combination with one or more of the first aspect through the eleventh aspect, the first network entity is configured to perform a TDD switch during the first RTT. The TTD switch is performed during the second portion of the first RTT.

In a thirteenth aspect, in combination with one or more of the first aspect through the twelfth aspect, the techniques further include transmitting UE capability information.

In a fourteenth aspect, in combination with the thirteenth aspect, the UE capability information indicates: a band, a band combination, a CA combination, or a combination thereof available for carrier phase reporting.

In a fifteenth aspect, in combination with one or more of the thirteenth aspect or the fourteenth aspect, the UE capability information indicates: an ability to maintain a phase during a TDD switch.

In a sixteenth aspect, in combination with one or more of the thirteenth aspect or the fifteenth aspect, the UE capability information indicates. a duration the phase is able to be maintained during the TTD switch.

In a seventeenth aspect, in combination with one or more of the first aspect through the sixteenth aspect, the techniques further include receiving capability information from the first network entity, the capability information associated with the first RTT.

In an eighteenth aspect, in combination with one or more of the first aspect through the seventeenth aspect, the techniques further include determining scheduling information associated with the first RTT.

In a nineteenth aspect, in combination with one or more of the first aspect through the eighteenth aspect, the techniques further include performing the first RTT with the first network entity, the first RTT associated with a first DL carrier frequency and a first UL carrier frequency.

In a twentieth aspect, in combination with the nineteenth aspect, the techniques further include performing the second RTT with the second network entity, the second RTT associated with a second DL carrier frequency and a second UL carrier frequency.

In a twenty-first aspect, in combination with the twentieth aspect, the techniques further include transmitting an indicator of the first DL carrier frequency, the first UL carrier frequency, or a combination thereof to an LMF.

In a twenty-second aspect, in combination with the twentieth aspect, the first DL carrier frequency and the first UL carrier frequency are associated with a PRS or an SRS.

In a twenty-third aspect, in combination with the twentieth aspect, the first DL carrier frequency and the first UL carrier frequency have different bandwidths.

In a twenty-fourth aspect, in combination with the twentieth aspect, the first DL carrier frequency and the first UL carrier frequency have the same center frequency.

In a twenty-fifth aspect, in combination with the twenty-fourth aspect, the center frequency of the first DL carrier frequency is a the center of a configured PFL or a BW.

In a twenty-sixth aspect, in combination with one or more of the first aspect through the twenty-fifth aspect, the techniques further include performing a third RTT with a third network entity, the third RTT associated with a third DL carrier frequency and a third UL carrier frequency.

In a twenty-seventh aspect, in combination with the twenty-sixth aspect, the techniques further include generating, by the UE, third DL phase information based on the third RTT associated with the first network entity.

In a twenty-eighth aspect, in combination with the twenty-seventh aspect, the position is determined based on the third DL phase information.

In a twenty-ninth aspect, in combination with one or more of the first aspect through the twenty-eighth aspect, the techniques further include transmitting the first DL phase information to a location management function LMF.

In a thirtieth aspect, in combination with the twenty-ninth aspect, the techniques further include transmitting the second DL phase information to the LMF.

In a thirty-first aspect, in combination with the thirtieth aspect, obtaining the position includes receiving the position from the LMF.

In a thirty-second aspect, in combination with one or more of the first aspect through the thirty-first aspect, the techniques further include receiving first UL phase information based on the first RTT, the first UL phase information determined by the first network entity.

In a thirty-third aspect, in combination with the thirty-second aspect, the techniques further include receiving second UL phase information based on the first RTT, the second UL phase information determined by the second network entity.

In a thirty-fourth aspect, in combination with the thirty-third aspect, obtaining the position includes determining the position based on a first DL carrier frequency associated with the first RTT, a first UL carrier frequency associated with the first RTT, a second DL carrier frequency associated with the second RTT, a second UL carrier frequency associated with the second RTT, or a combination thereof.

In a thirty-fifth aspect, in combination with the thirty-third aspect, the techniques further include determining a first constraint based on first RTT information associated with the first RTT, the first RTT information including the first DL phase information, the first UL phase information, a first DL carrier frequency associated with the first RTT, a first UL carrier frequency associated with the first RTT, a first DL parameter, and a first UL parameter.

In a thirty-sixth aspect, in combination with the thirty-fifth aspect, the techniques further include determining a second constraint based on second RTT information associated with the second RTT, the second RTT information including the second DL phase information, the second UL phase information, a second DL carrier frequency associated with the second RTT, a second UL carrier frequency associated with the second RTT, a second DL parameter and a second UL parameter.

In a thirty-seventh aspect, in combination with the thirty-sixth aspect, the first DL parameter includes a first DL cycle ambiguity and the first UL parameter includes a first UL cycle ambiguity.

In a thirty-eighth aspect, in combination with the thirty-seventh aspect, the first DL parameter includes a first integer value and the first UL parameter includes a second integer value.

In a thirty-ninth aspect, in combination with the thirty-eighth aspect, the first integer value represents a first number of wavelength associated with the first DL carrier frequency, and the second integer value represents a second number of wavelengths associated with the first UL carrier frequency.

In a fortieth aspect, in combination with one or more of the first aspect through the thirty-ninth aspect, the first constraint is associated with a first condition that is equal to a second condition.

In a forty-first aspect, in combination with one or more of the first aspect through the fortieth aspect, the first condition is based on a wavelength of the first DL carrier frequency multiplied by a sum of the first DL parameter and a first fractional wavelength value, the first fractional wavelength value based on the first DL phase information.

In a forty-second aspect, in combination with one or more of the first aspect through the forty-first aspect, the second condition is based on a wavelength of the first UL carrier frequency multiplied by a sum of the first UL parameter and a second fractional wavelength value, the second fractional wavelength value based on the first UL phase information.

In a forty-third aspect, in combination with the thirty-fifth aspect, the techniques further include determining a first set of candidate values for the first DL parameter and the first UL parameter that satisfy the first constraint.

In a forty-fourth aspect, in combination with the forty-third aspect, the techniques further include determining a second set of candidate values for the second DL parameter and the second UL parameter that satisfy the second constraint.

In a forty-fifth aspect, in combination with the forty-fourth aspect, the techniques further include determining the position associated with the UE based on the first set of candidate values and the second set of candidate values.

In a forty-sixth aspect, in combination with the forty-fifth aspect, the first set of candidate values includes one or more candidate pairs of DL and UL parameters that satisfy the first constraint.

In some aspects, techniques for supporting RTT for NR may include additional aspects, such as any single aspect or any combination of aspects described below or in connection with one or more other processes or devices described elsewhere herein. In a forty-seventh aspect, techniques for supporting RTT for NR may include receiving multiple sets of RTT information associated with a UE, each RTT information of the multiple sets of RTT information associated with a different network entity; and determining a position associated with the UE based on the multiple sets of RTT information. In some examples, the techniques in the forty-seventh may be implemented in a method or process. In some other examples, the techniques of the forty-seventh may be implemented in a device such as a network entity, a component of a network entity, or a UE or a component of a UE. In some examples, the device may include at least one processing unit or system (which may include an application processor, a modem or other components) and at least one memory device coupled to the processing unit. The processing unit may be configured to perform operations described herein with respect to the device. In some examples, the memory device includes a non-transitory computer-readable medium having program code stored thereon that, when executed by the processing unit, is configured to cause the wireless communication device to perform the operations described herein. Additionally, or alternatively, the device may include one or more means configured to perform operations described herein.

In a forty-eighth aspect, in combination with the forty-seventh aspect, the techniques further include transmitting an indicator that indicates the position.

In a forty-ninth aspect, in combination with the forty-seventh aspect or the forty-eighth aspect, each RTT information of the multiple sets of RTT information including DL phase information, UL phase information, a DL carrier frequency, and a UL carrier frequency.

In a fiftieth aspect, in combination with the forty-ninth aspect, the techniques further include determining, for each RTT information of the multiple sets of RTT information, a constraint.

In a fifty-first aspect, in combination with the fiftieth aspect, for each RTT information of the multiple sets of RTT information, the determined constraint is based on the DL phase information, the UL phase information, the DL carrier frequency, the UL carrier frequency, a respective DL parameter, and a respective UL parameter.

In a fifty-second aspect, in combination with the fifty-first aspect, for each RTT information of the multiple sets of RTT information, the DL parameter includes a DL cycle ambiguity and the UL parameter includes a UL cycle ambiguity.

In a fifty-third aspect, in combination with the fifty-first aspect, for each RTT information of the multiple sets of RTT information, the DL parameter includes a first integer value and the UL parameter includes a second integer value.

In a fifty-fourth aspect, in combination with the fifty-third aspect, for each RTT information of the multiple sets of RTT information, the integer value represents a first number of wavelengths associated with the DL carrier frequency, and the second integer value represents a second number of wavelengths associated with the UL carrier frequency.

In a fifty-fifth aspect, in combination with the fifty-first aspect, for each RTT information of the multiple sets of RTT information: the determined constraint is associated with a first condition that is equal to a second condition.

In a fifty-sixth aspect, in combination with the fifty-fifth aspect, for each RTT information of the multiple sets of RTT information, the first condition is based on a wavelength of the DL carrier frequency multiplied by a sum of the DL parameter and a first fractional wavelength value. In some implementations, the first fractional wavelength value based on the DL phase information.

In a fifty-seventh aspect, in combination with the fifty-sixth aspect, for each RTT information of the multiple sets of RTT information, the second condition is based on a wavelength of the UL carrier frequency multiplied by a sum of the UL parameter and a second fractional wavelength value. In some implementations, the second fractional wavelength value based on the UL phase information.

In a fifty-eighth aspect, in combination with the fifty-seventh aspect, the techniques further include, for each RTT information of the multiple sets of RTT information, determining a set of candidate values for the DL parameter and the UL parameter that satisfy the constraint determined for the RTT information.

In a fifty-ninth aspect, in combination with the fifty-eighth aspect, the techniques further include determining the position associated with the UE based on the set of candidate values of each RTT information of the multiple sets of RTT information.

In a sixtieth aspect, in combination with the fifty-seventh aspect, for each RTT information of the multiple sets of RTT information, the set of candidate values includes one or more candidate pairs of DL and UL parameters that satisfy the constraint the RTT information.

In a sixty-first aspect, in combination with one or more of the forty-seventh aspect through the sixtieth aspect, the network entity includes a UE, a BS, a core network, an LMF.

In a sixty-second aspect, in combination with the sixty-first aspect, each different network entity includes a UE, a BS, or an Internet-of-Things (IoT) device.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
generating, by a UE, first downlink (DL) phase information based on a first round trip time (RTT) associated with a first network entity;
generating, by the UE, second DL phase information based on a second RTT associated with a second network entity; and
obtaining, by the UE, a position associated with the UE based on the first DL phase information and the second DL phase information.

2. The method of claim 1, further comprising:
maintaining an internal carrier phase during at least a portion of the first RTT;
performing a time division duplex (TDD) switch during the first RTT, wherein the portion of the first RTT includes the TDD switch; and
wherein the first network entity is configured to maintain an internal carrier phase associated with the first network entity, and
wherein:
the first DL phase information includes an observed phase measured based on a downlink signal received via a receive component of the UE;
the RTT includes a new radio (NR) RTT;
the UE, the first network entity, and the second network entity are included in an asynchronous network;
the first RTT and the second RTT are associated with side link (SL) positioning operations; or
a combination thereof.

3. The method of claim 1, further comprising:
transmitting UE capability information, wherein the UE capability information indicates:
a band, a band combination, a carrier aggregation (CA) combination, or a combination thereof available for carrier phase reporting;
an ability to maintain a phase during a time division duplex (TDD) switch;
a duration the phase is able to be maintained during the TTD switch; or
a combination thereof; and
determining scheduling information associated with the first RTT.

4. The method of claim 1, further comprising:
performing the first RTT with the first network entity, the first RTT associated with a first DL carrier frequency and a first uplink (UL) carrier frequency; and
performing the second RTT with the second network entity, the second RTT associated with a second DL carrier frequency and a second UL carrier frequency, and
wherein:
the first DL carrier frequency and the first UL carrier frequency have different bandwidths;
the first DL carrier frequency and the first UL carrier frequency have the same center frequency; or
a combination thereof.

5. The method of claim 1, further comprising:
transmitting the first DL phase information to a location management function (LMF); and
transmitting the second DL phase information to the LMF; and
wherein obtaining the position includes receiving the position from the LMF.

6. The method of claim 1, further comprising:
receiving first UL phase information based on the first RTT, the first UL phase information determined by the first network entity; and
receiving second UL phase information based on the first RTT, the second UL phase information determined by the second network entity, and
wherein obtaining the position includes determining the position based on a first DL carrier frequency associated with the first RTT, a first UL carrier frequency associated with the first RTT, a second DL carrier frequency associated with the second RTT, a second UL carrier frequency associated with the second RTT, or a combination thereof.

7. The method of claim 1, further comprising:
receiving first UL phase information based on the first RTT, the first UL phase information determined by the first network entity;
receiving second UL phase information based on the first RTT, the second UL phase information determined by the second network entity
determining a first constraint based on first RTT information associated with the first RTT, the first RTT information including the first DL phase information, the first UL phase information, a first DL carrier frequency associated with the first RTT, a first UL carrier frequency associated with the first RTT, a first DL parameter, and a first UL parameter; and
determining a second constraint based on second RTT information associated with the second RTT, the second RTT information including the second DL phase information, the second UL phase information, a second DL carrier frequency associated with the second RTT, a second UL carrier frequency associated with the second RTT, a second DL parameter and a second UL parameter.

8. The method of claim 7, wherein:
the first DL parameter includes a first DL cycle ambiguity and the first UL parameter includes a first UL cycle ambiguity;
the first DL parameter includes a first integer value and the first UL parameter includes a second integer value; and
the first integer value represents a first number of wavelength associated with the first DL carrier frequency, and the second integer value represents a second number of wavelengths associated with the first UL carrier frequency.

9. The method of claim 7, wherein:
the first constraint is associated with a first condition that is equal to a second condition;
the first condition is based on a wavelength of the first DL carrier frequency multiplied by a sum of the first DL parameter and a first fractional wavelength value, the first fractional wavelength value based on the first DL phase information; and
the second condition is based on a wavelength of the first UL carrier frequency multiplied by a sum of the first UL parameter and a second fractional wavelength value, the second fractional wavelength value based on the first UL phase information.

10. The method of claim 7, further comprising:
determining a first set of candidate values for the first DL parameter and the first UL parameter that satisfy the first constraint, wherein the first set of candidate values includes one or more candidate pairs of DL and UL parameters that satisfy the first constraint;
determining a second set of candidate values for the second DL parameter and the second UL parameter that satisfy the second constraint; and
determining the position associated with the UE based on the first set of candidate values and the second set of candidate values.

11. A user equipment (UE) comprising:
a memory storing processor-readable code; and
at least one processor coupled to the memory, the at least one processor configured to execute the processor-readable code to cause the at least one processor to:
generate first downlink (DL) phase information based on a first round trip time (RTT) associated with a first network entity;
generate second DL phase information based on a second RTT associated with a second network entity; and
obtain a position associated with the UE based on the first DL phase information and the second DL phase information.

12. The UE of claim 11, wherein the at least one processor is further configured to execute the processor-readable code to cause the at least one processor to:
initiate transmission of the first DL phase information to a location management function (LMF); and
initiate transmission of the second DL phase information to the LMF; and
wherein, to obtain the position, the position is received from the LMF.

13. The UE of claim 11, wherein the at least one processor is further configured to execute the processor-readable code to cause the at least one processor to:
receive first UL phase information based on the first RTT, the first UL phase information determined by the first network entity; and
receive second UL phase information based on the first RTT, the second UL phase information determined by the second network entity, and
determine the position based on a first DL carrier frequency associated with the first RTT, a first UL carrier frequency associated with the first RTT, a second DL carrier frequency associated with the second RTT, a second UL carrier frequency associated with the second RTT, or a combination thereof.

14. The UE of claim 11, wherein the at least one processor is further configured to execute the processor-readable code to cause the at least one processor to:
receive first UL phase information based on the first RTT, the first UL phase information determined by the first network entity;
receive second UL phase information based on the first RTT, the second UL phase information determined by the second network entity
determine a first constraint based on first RTT information associated with the first RTT, the first RTT information including the first DL phase information, the first UL phase information, a first DL carrier frequency associated with the first RTT, a first UL carrier frequency associated with the first RTT, a first DL parameter, and a first UL parameter; and
determine a second constraint based on second RTT information associated with the second RTT, the second RTT information including the second DL phase information, the second UL phase information, a second DL carrier frequency associated with the second RTT, a second UL carrier frequency associated with the second RTT, a second DL parameter and a second UL parameter.

15. The UE of claim 14, wherein the at least one processor is further configured to execute the processor-readable code to cause the at least one processor to:
determine a first set of candidate values for the first DL parameter and the first UL parameter that satisfy the first constraint, wherein the first set of candidate values includes one or more candidate pairs of DL and UL parameters that satisfy the first constraint;
determine a second set of candidate values for the second DL parameter and the second UL parameter that satisfy the second constraint; and
determine the position associated with the UE based on the first set of candidate values and the second set of candidate values.

16. A method of wireless communication performed by a network entity, the method comprising:
receiving, at a network entity, multiple sets of round trip time (RTT) information associated with a user equipment (UE), each RTT information of the multiple sets of RTT information associated with a different network entity; and
determining a position associated with the UE based on the multiple sets of RTT information.

17. The method of claim 16, further comprising transmitting an indicator that indicates the position.

18. The method of claim 16, further comprising:
determining, for each RTT information of the multiple sets of RTT information, a constraint; and
wherein each RTT information of the multiple sets of RTT information including downlink (DL) phase information, uplink (UL) phase information, a DL carrier frequency, and a UL carrier frequency.

19. The method of claim 18, wherein, for each RTT information of the multiple sets of RTT information, the determined constraint is based on the DL phase information, the UL phase information, the DL carrier frequency, the UL carrier frequency, a respective DL parameter, and a respective UL parameter.

20. The method of claim 19, wherein, for each RTT information of the multiple sets of RTT information, the DL parameter includes a DL cycle ambiguity and the UL parameter includes a UL cycle ambiguity.

21. The method of claim 19, wherein, for each RTT information of the multiple sets of RTT information, the DL parameter includes a first integer value and the UL parameter includes a second integer value, the first integer value represents a first number of wavelengths associated with the DL carrier frequency, and the second integer value represents a second number of wavelengths associated with the UL carrier frequency.

22. The method of claim 19, wherein, for each RTT information of the multiple sets of RTT information:
the determined constraint is associated with a first condition that is equal to a second condition;
the first condition is based on a wavelength of the DL carrier frequency multiplied by a sum of the DL parameter and a first fractional wavelength value, the first fractional wavelength value based on the DL phase information; and
the second condition is based on a wavelength of the UL carrier frequency multiplied by a sum of the UL parameter and a second fractional wavelength value, the second fractional wavelength value based on the UL phase information.

23. The method of claim 22, further comprising:
for each RTT information of the multiple sets of RTT information, determining a set of candidate values for the DL parameter and the UL parameter that satisfy the constraint determined for the RTT information; and
determining the position associated with the UE based on the set of candidate values of each RTT information of the multiple sets of RTT information.

24. The method of claim 22, wherein, for each RTT information of the multiple sets of RTT information, the set of candidate values includes one or more candidate pairs of DL and UL parameters that satisfy the constraint the RTT information.

25. A network entity comprising:
a memory storing processor-readable code; and
at least one processor coupled to the memory, the at least one processor configured to execute the processor-readable code to cause the at least one processor to:
receive multiple sets of round trip time (RTT) information associated with a user equipment (UE), each RTT information of the multiple sets of RTT information associated with a different network entity; and
determine a position associated with the UE based on the multiple sets of RTT information.

26. The network entity of claim 25, wherein the at least one processor is further configured to execute the processor-readable code to cause the at least one processor to initiate transmission of an indicator that indicates the position.

27. The network entity of claim 25, wherein the at least one processor is further configured to execute the processor-readable code to cause the at least one processor to:
determine, for each RTT information of the multiple sets of RTT information, a constraint;
wherein each RTT information of the multiple sets of RTT information including downlink (DL) phase information, uplink (UL) phase information, a DL carrier frequency, and a UL carrier frequency; and
wherein, for each RTT information of the multiple sets of RTT information, the determined constraint is based on the DL phase information, the UL phase information, the DL carrier frequency, the UL carrier frequency, a respective DL parameter, and a respective UL parameter.

28. The network entity of claim 27, wherein, for each RTT information of the multiple sets of RTT information:
the determined constraint is associated with a first condition that is equal to a second condition;
the first condition is based on a wavelength of the DL carrier frequency multiplied by a sum of the DL parameter and a first fractional wavelength value, the first fractional wavelength value based on the DL phase information; and
the second condition is based on a wavelength of the UL carrier frequency multiplied by a sum of the UL parameter and a second fractional wavelength value, the second fractional wavelength value based on the UL phase information.

29. The network entity of claim 28, wherein the at least one processor is further configured to execute the processor-readable code to cause the at least one processor to:
for each RTT information of the multiple sets of RTT information, determine a set of candidate values for the DL parameter and the UL parameter that satisfy the constraint determined for the RTT information; and
determine the position associated with the UE based on the set of candidate values of each RTT information of the multiple sets of RTT information.

30. The network entity of claim 28, wherein, for each RTT information of the multiple sets of RTT information, the set of candidate values includes one or more candidate pairs of DL and UL parameters that satisfy the constraint the RTT information.
